(19) United States
(12) Patent Application Publication
(10) Pub. No.: US 2010/0296293 A1
(43) Pub. Date: Nov. 25, 2010

(54) OSCILLATION DAMPER

(76) Inventor: Vince Herbert, Warwickshire (GB)

Correspondence Address: MCDONALD HOPKINS LLC, 600 Superior Avenue, East, Suite 2100, CLEVELAND, OH, 44114-2653, US

(21) Appl. No.: 12/669,542

(22) PCT Filed: Jul. 15, 2008
(86) PCT No.: PCT/GB08/02392

§ 371 Date: May 25, 2010

(30) Foreign Application Priority Data
Jul. 17, 2007 (GB) 0713862.1

(51) Int. Cl. F16F 15/02; F16F 7/10; F21V 23/00

(52) U.S. Cl. 362/276; 188/378

(57) ABSTRACT

A damping system for damping oscillation of a moving structure comprises a flywheel, a motor arranged to drive the flywheel, sensing means arranged to detect movement of the structure and control means arranged to control the motor in response to detected movement of the structure.

The present invention relates to a device for damping movement, and in particular for damping oscillation of a suspended or mounted device such as stage lighting units, image projectors, cameras or scenery.

The entertainment industry has used moving lights for many years. These lights can be remotely focussed, panned or moved sideways, tilted or moved up or down and coloured without the need for operator access via ladders or other means. The design of some video projectors incorporates remote controlled panning, tilting and focusing capabilities giving them the means of projecting an image onto many different screens or surfaces. Remotely controlled video and film cameras are also widely used. In theatres, television studios, arenas or other similar venues, lighting units are currently hung or supported on wall or ceiling mounted rigs, floor supported truss systems, hanging truss systems, counterweighted bars or substantial floor stands. Panning or tilting a moving light, projector or camera generates rotational torque in an unsecured frame or flying structure, which can cause oscillation and render a unit unusable for several minutes. In certain cases, scenery is suspended above a stage area out of sight of the audience and when required, is lowered into view. This action can sometimes generate a rotational movement in that piece of scenery. Current mountings therefore need to be of a sufficient mass or have a strong enough anchorage so as not to be affected by the rotational torque transmitted to the structure when panning or tilting a moving light, projector or camera or when moving scenery.

The present invention has useful applications in broadcast and film, performing arts, corporate events, night entertainment, concerts and touring venues, amusement attractions and sporting events, as well as stabilizing technology in boats, on loads carried by cranes, on loads suspended from a winch, on loads suspended from helicopters in rescue or similar scenarios or on motor vehicles that experience unwanted sideways rocking motions.

The present invention provides a damping system for damping oscillation of a moving structure, the system comprising a flywheel, a motor arranged to drive the flywheel, sensing means arranged to detect movement of the structure and control means arranged to control the motor in response to detected movement of the structure.

The flywheel may comprise balanced, connected weights able to rotate about a central point or the rotor section of a motor that is able to spin about a centre point.

Preferably, the sensing means is arranged to continuously monitor the position of the structure and to send a signal to the control means indicative of any change in position of the structure. The sensing means may be arranged to detect oscillating motion of the structure and the control means may be arranged to accelerate and decelerate the flywheel in response to such motion.

The acceleration and deceleration of the flywheel may be timed with respect to the sensed oscillation. The control means may comprise a logic control system storing a control programme and a motor amplifier arranged to control the direction and speed of the motor. The control means may alternatively directly control the direction and speed of the motor in proportion to the output of the sensing device.

The flywheel may be arranged to be accelerated to move in the same direction as the moving structure when movement of the structure is first detected. The flywheel may also be arranged to be decelerated on detection of a change in direction of movement of the structure. Preferably, the velocity of the flywheel is arranged to be at a minimum when the displacement of the structure is at or near minimum.

Preferably, the sensing means is any one of an angular rate sensor, accelerometer, gyroscope, solid state gyroscope or any other suitable sensing means.

The device may further comprise a power supply arranged to power the device and arranged to convert a supplied voltage, for example mains voltage, to a usable DC voltage.

The motor may be mounted on one side of a chassis and may be on the central axis of the flywheel or at an angle to the flywheel. The motor may be connected to the flywheel by a drive shaft or drive-belt or gears or a rotating component of the motor may itself be of sufficient mass to constitute at least a part of the flywheel. The motor may be of such a design as to limit or eliminate any noise generated by its movement. The power supply, control means and sensing means may also be supported on the chassis.

Preferably, the device is contained within a housing, which is arranged to be attached to the hanging structure. For example, the housing may be clamped to a hanging bar, bolted to a structure or mounted in any other suitable way as to efficiently transmit the movement generated by the acceleration and deceleration of the flywheel to the hanging structure. The hanging structure may be a suspended frame or bar, a theatre truss, a television pantograph, or a platform arranged to support a moving light, projector or camera for example, or may be hanging scenery. The hanging structure may be suspended on a plurality of support lines and the housing, and therefore the flywheel, may be placed within a volume at least partially defined by the plurality of support lines.

The device may if necessary, be attached in vertical plane, rotating about a horizontal axis to the hanging structure to dampen forward and backward or nodding motion of the suspended structure.

The device may comprise a plurality of flywheels. Each flywheel may be driven by a respective motor, each able to rotate independently of each other. Alternatively, a single motor may drive a plurality of flywheels.

According to a second aspect of the invention, there is provided a method of damping an oscillating structure comprising monitoring movement of the structure, using a motor to drive a flywheel and controlling the direction and speed of the motor in response to the movement of the structure.

Preferably, the method comprises using control means to control an appropriate acceleration and deceleration of the flywheel in response to movement of the structure.

Preferred embodiments of the invention will now be described with reference to the accompanying drawings, in which:

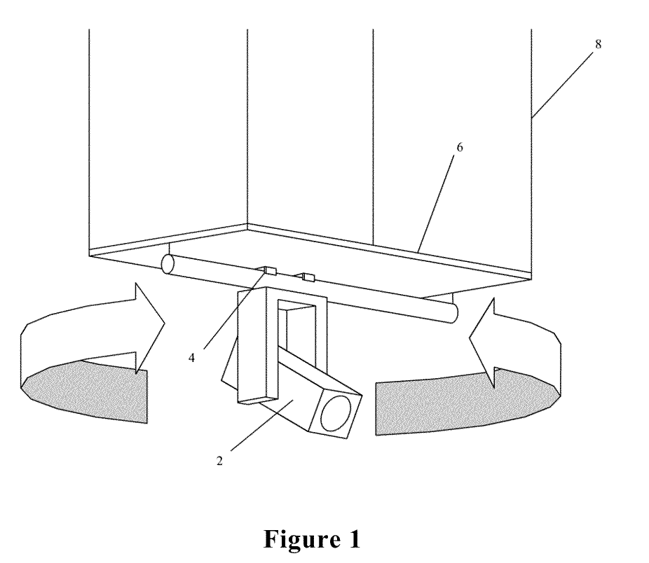

FIG. 1 is a schematic illustration of a moving light supported on a hanging structure;

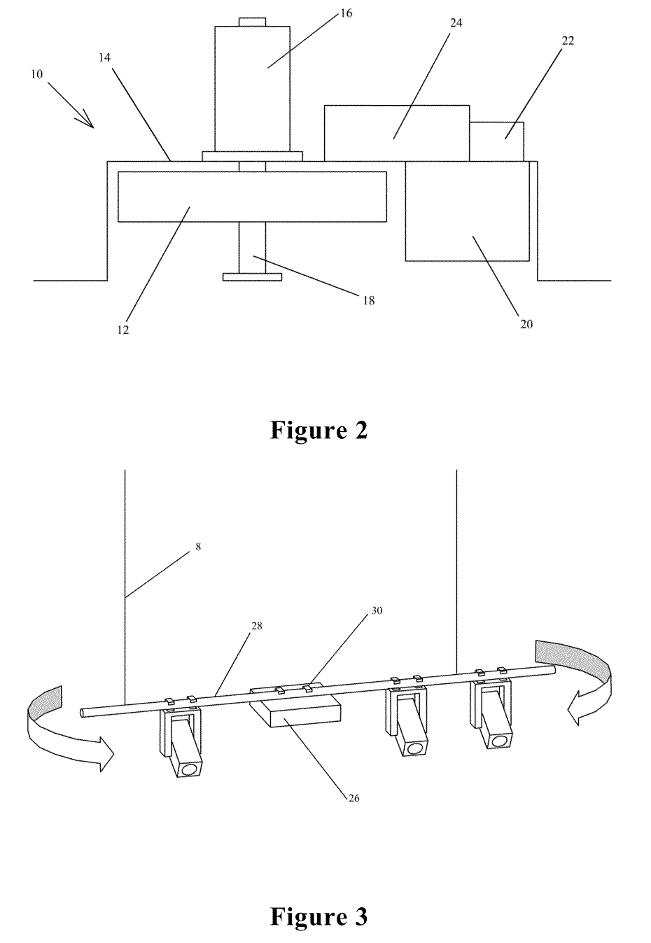

FIG. 2 is a schematic representation of the damping system of the present invention;

FIG. 3 is a schematic illustration of the damping system of FIG. 2 attached to a support bar;

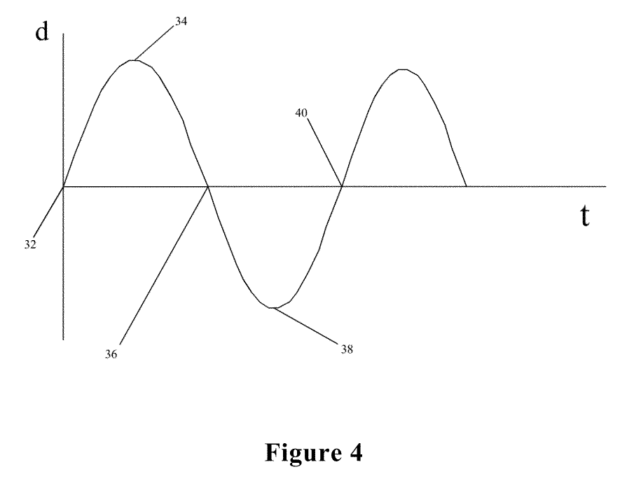

FIG. 4 is a graph of a sine wave illustrating the simple harmonic motion of the hanging structure;

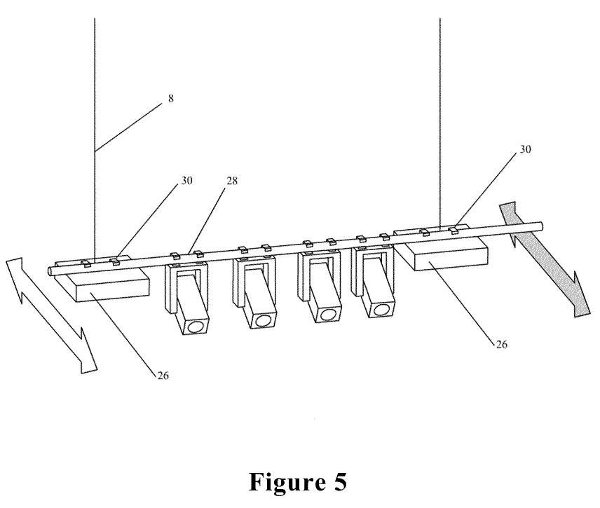

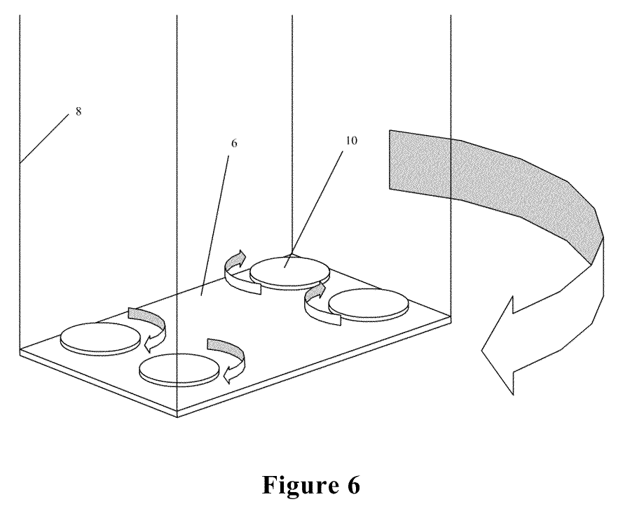

FIG. 5 is a schematic illustration of a damping system comprising a plurality of flywheels attached to a support bar;

FIG. 6 is a schematic illustration of a damping system comprising a plurality of flywheels;

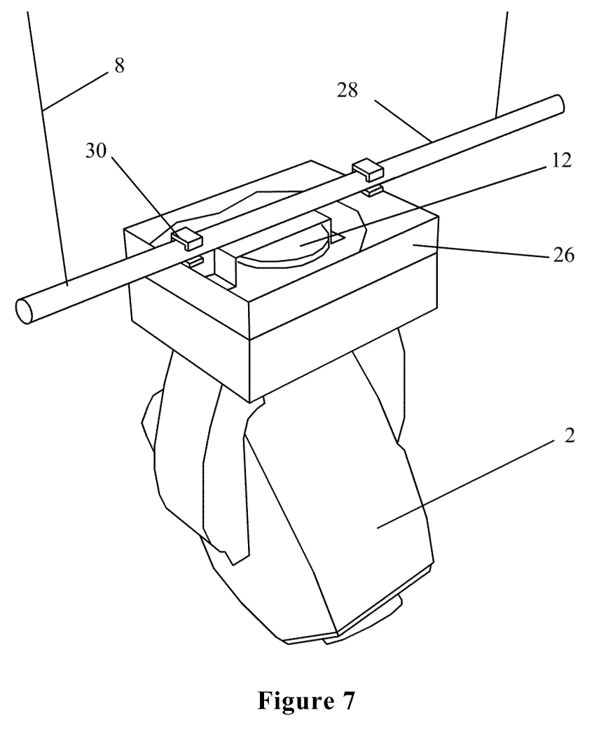

FIG. 7 is a schematic illustration of a damping system of FIG. 2 incorporated into the construction of a moving light unit; and

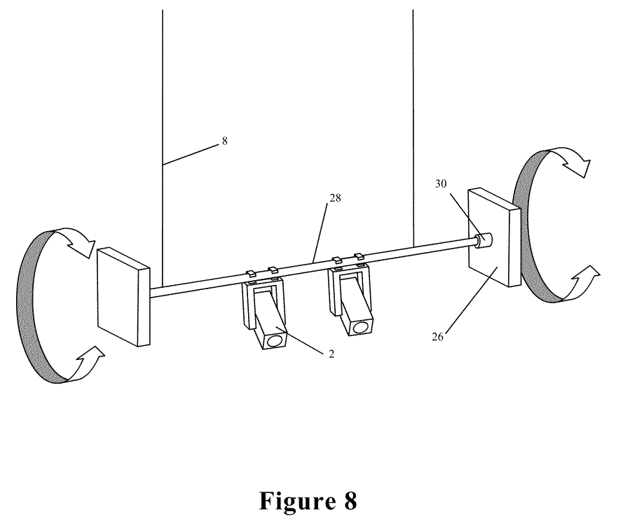

FIG. 8 is a schematic illustration of a damping system mounted in the vertical plane to eliminate nodding oscillation.

Referring to FIG. 1, a moving light 2 is mounted by support brackets 4 on a hanging support frame 6. The hanging frame 6 is suspended by four hanging lines 8, each attached to a respective corner of the hanging structure 6. In use, motors drive movement of the light 2 and are controlled remotely by an operator. The light can be controlled to pan or tilt and as it moves, rotational torque is applied to the hanging frame 6. The acceleration and deceleration of the moving light 2 induces an unwanted rotational oscillating motion of the hanging frame 6 about the centre of the area defined by the four hanging lines 8. The oscillating motion is harmonic motion and may be approximated to simple harmonic motion. The amplitude of these oscillations gradually decreases over time. For example, a hanging structure weighing approximately 100 kg supported on hanging lines of around 15 m would swing with harmonic motion with a duty cycle time period of approximately 1 s. Under these conditions the oscillations would typically continue for over 8 minutes before naturally coming to a stop, rendering the light unusable for this period.

Referring to FIG. 2, a damping system 10 is arranged to be clamped or attached to the hanging structure 6 and comprises a flywheel 12 mounted onto a shaft 18. The shaft 18 extends through the centre of the flywheel 12 and is arranged to rotate about its central axis. A motor 16 controls rotation of the flywheel 12 by driving the shaft 18. The motor 16 is mounted on one side of a chassis 14 and the shaft 18 extends through the chassis 14 to the flywheel on the opposite side of the chassis. Also mounted to the chassis is a power supply 24 that converts mains voltage to a suitable DC voltage to power the system. The power supply 24 is connected to an electronic control system 20 arranged to control the speed and direction of the motor 16 by varying the voltage or current and polarity of the voltage supplied to the motor in magnitude, frequency or polarity. A motion sensor 22 is also mounted to the chassis 14 and is connected to the electronics unit 20.

The motion sensor 22 continuously monitors its own position and therefore detects any oscillatory movement of the hanging structure 6. In one embodiment of the invention the motion sensor 22 is an angular rate sensor, although it will be appreciated that an accelerometer, gyroscope, solid state gyroscope or any other suitable measuring means may be used. When motion of the hanging frame 6 is detected, the motion sensor sends a signal to the logic control system and motor amplifier 20, which drives the motor 16 in response to this signal.

Referring to FIG. 4, the rotational simple harmonic oscillation of the hanging frame 6 can be described as a sine curve of displacement d of the frame about a central reference point 32 against time t. As soon as motion of the hanging structure 6 is detected at point 32, the motor 16 drives the shaft 18 to rotate the flywheel 12. Initially, the flywheel is accelerated to move in the same direction as the movement of the hanging frame 6. The velocity of the moving frame decreases as the displacement of the frame approaches a maximum. This can be determined by the gradient of the plot of displacement against time. The acceleration of the moving frame as it moves towards its point of maximum displacement is a negative acceleration and the initial acceleration of the flywheel is therefore in an opposite direction to the acceleration of the moving frame 6 to cause the flywheel to rotate in the same direction as the moving frame. The acceleration of the flywheel is timed and controlled by the logic control system.

At the point 34 of maximum positive displacement of the hanging frame 6, shown by the amplitude of the sine wave, the velocity of the structure is zero and a change in direction is detected by the motion sensor 22 as the structure begins to swing back towards its starting point of zero displacement 36. On detection of this change, as the hanging frame accelerates towards the point of zero displacement, the flywheel begins a timed deceleration until it reaches a velocity of zero close to the point 36 of maximum velocity and zero displacement of the hanging structure 6. At this point, the hanging frame begins to decelerate and the flywheel 12 reverses and is accelerated to move in the same direction as the hanging frame 6 until the hanging structure 6 reaches its point of maximum negative displacement shown at point 38. Again, the change in direction of the hanging structure at point 38 is detected by the motion sensor 22 and, as the hanging frame 6 accelerates, the flywheel 12 begins a timed deceleration until it reaches a velocity of zero close to the point 40 of maximum velocity and zero displacement of the hanging structure 6.

The controlled motion of the flywheel 12 dampens the rotational oscillation of the hanging structure 6, reducing the amplitude of oscillation, by removing energy from the structure during every period of oscillation until the structure comes to rest.

The timing of movement of the flywheel 12 can be controlled by the logic control system of the electronics unit 20. A control programme can be stored in the logic control system using solid-state electronic storage and is arranged to receive signals from the motion sensor indicative of movement of the hanging structure 6. The logic control system and motor amplifier control the speed and direction of the motor in response to the motion sensor signal. Any control programme can be updated externally if necessary.

Controlling the acceleration of the flywheel controls the damping force, enabling the desired damping forces to be achieved using a flywheel of known mass. It will be appreciated that the mass of the flywheel therefore has an affect on the damping force. A flywheel with a greater mass driven with a particular acceleration will generate a greater damping force than a flywheel with smaller mass driven with the same acceleration and the oscillating frame 6 will therefore come to a stop quicker. However, a flywheel with greater mass would clearly need a more powerful motor to drive it with that acceleration. The damping efficiency is therefore also affected by the speed, power and reaction time of the motor. An oscillating hanging structure 6 has been shown to come to rest after an average of a single cycle, enabling the moving light 2 to be used again almost immediately. It may even be possible to bring the oscillating structure to a stop after only half a cycle.

In a modification to this embodiment, the logic control system and amplifier 20 is replaced by a simple amplifier which is arranged to receive the signals directly from the motion sensor 22 and output a drive signal directly to the motor 16. In this case the speed of the motor is arranged to be proportional to the acceleration of the hanging frame 6. The timing and control of the motor is in this case provided directly in response to the output from the motion sensor 22. If the motion sensor 22 outputs a signal proportional to rotational acceleration, then the drive signal to the motor, which controls the speed and direction of the motor, can be simply in proportion to the sensor signal. If the sensor signal were proportional to the velocity of the frame 6, then the acceleration and deceleration of the flywheel would be controlled so as to be proportional to the sensor signal.

The chassis 14 is made from metal that is sufficiently thick to minimise any flex that may be transmitted to it and the flywheel 12 is made from lathe turned or appropriately cut high density metal. However, it will be appreciated that any suitable material may be used. A system of balanced, connected weights able to rotate about a central point may also be used as the flywheel or even the rotor section of a motor that is able to spin about a centre point with sufficient mass and speed to generate the required moment of inertia.

Referring to FIG. 3, the damping device 10 operates independently without the need for external control signals and can therefore be conveniently housed in a container 26. The container 26 is metal and is clamped using clamps 30 to the frame 6 or to a lighting bar 28. Alternatively, the contained device can be fitted or clamped to any other structure requiring damping such as a hanging structure, a theatre truss, a television pantograph, a camera platform, hanging scenery or light-weight theatre cluster unit. The lighting bar 28 is suspended on two hanging lines 8 and is moving with a rotational oscillation about a point along the length of the lighting bar 28 between the two hanging lines 8. It is not necessary for the damping device 10 to be at the centre of gravity of the moving structure and so the damping device is clamped to the lighting bar at any point along its length between the two hanging lines 8. It is orientated such that rotation of the flywheel 12 is in the same plane as oscillation of the lighting bar.

The damping effect can be increased by placing a number of flywheels 12 on a moving structure. For example, a number of self-contained damping systems 10 can be placed side by side or stacked on top of each other, increasing the damping effect in direct proportion to the number of damping devices used. Each self-contained system is independently controlled and driven. However, it will be appreciated that it would be possible in some circumstances to drive a number of flywheels collectively with a single motor.

Referring to FIG. 5, two damping devices are clamped using clamps 30 to a lighting bar 28. The lighting bar is oscillating laterally, in a forwards and backwards swinging motion. The lighting bar 28 and the hanging lines 8 effectively form a pendulum. The two flywheels are controlled and driven independently and their rotation is controlled to compensate for this lateral swing. In this embodiment, the flywheels are arranged to operate alternately so that when the lighting bar 28 is swinging forwards a flywheel on one side spins in an appropriate direction to force the opposite side of the lighting bar back towards the rest position. When the lighting bar 28 swings backwards the other flywheel spins in the appropriate direction to force the opposite side of the lighting bar towards its resting position. The combined effect of the flywheels dampens the swing of the lighting bar and brings it to rest in a shorter period of time.

As shown in FIG. 6, multiple damping devices 10 can be used to increase the damping effect on a rotationally oscillating structure 6. In this illustration, four damping devices 10 are attached to the hanging structure 6 and are driven such that each flywheel rotates in the same direction and in the manner described above with reference to FIG. 4. The damping devices are arranged in a symmetrical manner across the upper surface of the hanging structure 6. However, it is not essential for the flywheels 12 to be placed at or distributed evenly about the centre of gravity of the structure 6 and it will therefore be appreciated that the damping devices 10 may be placed in an off-set arrangement. The combined effect of the four damping devices results in an improved damping efficiency.

Referring to FIG. 7, in an alternative embodiment, the damping device is incorporated into the construction of the light as a self-contained unit. The housing 26 containing the flywheel 12 and other components is mounted onto the top of the moving light 2. The whole unit is then mounted onto a lighting bar 28 using clamps 30 attached to the upper outside surface of the container 26. In an alternative arrangement, the damping device may be mounted underneath the moving light 2. Incorporating a damping device in the light, or alternatively in a camera, projector or other suspended device means that the entire unit can easily be moved as required without having to attach a damping device each time.

Referring to FIG. 8, the damping devices do not have to be horizontal, but can be arranged in the vertical plane or at any other angle. Certain movements of a moving light 2 clamped to a lighting bar 28 can induce a rotational oscillatory movement of the bar 28 about its central longitudinal axis. This is known as a nodding motion. A damping device 10 is therefore attached vertically to the lighting bar 28, such that rotation of the flywheel 12 is about a horizontal axis in the same plane as rotation of the lighting bar to eliminate this effect. The motion sensor 22 detects the oscillatory motion of the lighting bar 28 and controls the speed and direction of the flywheel 12 accordingly, in the same way as described above for oscillation in a horizontal plane.

It will be appreciated that one or more damping devices may be attached to hanging structures in many different arrangements, according to the type of unwanted oscillatory movement experienced by the hanging structure. It will also be appreciated that there will be many ways of incorporating a damping device in a moving light, camera, projector, piece of scenery or other suspended article as a single unit, all within the scope of the invention.

As the device functions by introducing energy into a hanging structure in the opposite direction of the unwanted oscillation of a structure, it must be understood that if the anti-oscillation device is attached upside-down to any hanging structure, it would add to the oscillating with potentially dangerous consequences. As part of the construction of the device, fail-safe mechanisms should be incorporated to ensure that it would not be possible for this to happen. This could consist of a mercury switch mounted onto the unit in such a way so that the electrical supply would be cut off if the device were mounted in the wrong orientation. It may also be use the an angular rate sensor, accelerometer, gyroscope, solid state gyroscope or any other suitable sensing means to sense the orientation of the unit to either cut the power and thus rendering it safe or to reverse the polarity of the motor and thus ensuring that the device will always function safely.

1. A damping system for damping oscillation of a moving structure, the system comprising a flywheel, a motor arranged to drive the flywheel, at least one sensor arranged to detect movement of the structure and a controller arranged to control the motor in response to detected movement of the structure.

2. A system according to claim 1, wherein at least one sensor is arranged to monitor the position of the structure continuously and, in the event of a change in position of the structure, to send a signal to the controller indicative of the change in position.

3. A system according to claim 1, wherein the at least one sensor is arranged to detect oscillating motion of the structure and the controller is arranged to accelerate and decelerate the flywheel in response to the oscillating motion.

4. A system according to claim 3 wherein at least one sensor is arranged to produce a sensor output and the controller is arranged to control the acceleration or deceleration of the flywheel in direct proportion to the sensor output.

5. A system according to claim 4 wherein the controller is arranged to control controls the direction and speed of the motor in direct proportion to the sensor output.

6. A system according to claim 1, wherein the controller comprises an amplifier arranged to receive a signal from at least one sensor and output a drive signal to the motor.

7. A system according to claim 1, wherein the controller comprises a logic control system storing a control program and a motor amplifier arranged to control the direction and speed of the motor.

8. A system according to claim 1, wherein the controller is arranged to time the acceleration and deceleration of the flywheel with respect to the sensed oscillation.

9. A system according to claim 1, wherein the controller accelerates the flywheel to move in the same direction as the moving structure when movement of the structure is first detected.

10. A system according to claim 9, wherein the controller is arranged to detect a change in the direction of movement of the structure, and to decelerate the flywheel on detection of the change in direction of movement of the structure.

11. A system according to claim 9, wherein the velocity of the flywheel is arranged to be at a minimum when the displacement of the structure is at or near a minimum.

12. A system according to claim 1, further comprising a power supply arranged to power the system and arranged to receive a supplied voltage and to convert the supplied voltage to a usable DC voltage.

13. A system according to claim 1 further comprising a chassis, wherein the motor is mounted to one side of the chassis and is connected to the flywheel by at least one of a drive shaft, drive belt and gears.

14. A system according to claim 13, wherein the power supply, controller and at least one sensor are supported on the chassis.

15. A system according to claim 1 further comprising a housing arranged to be attached to the moving structure, wherein the flywheel, the motor and the controller are contained within housing.

16. (canceled)

17. (canceled)

18. (canceled)

19. A system according to any foregoing claim, wherein the flywheel forms part of the motor.

20. A system according to claim 1, wherein the system comprises a fail-safe mechanism to ensure that the anti-oscillation device always dampens the oscillation of the oscillating structure.

21. A system according to claim 1 wherein the structure is suspended and the system is arranged to damp swinging oscillations.

22. A lighting system including a light and a system according to claim 1 wherein the light is the moving structure.

23. (canceled)

24. A method of damping an oscillating structure comprising monitoring movement of the structure, using a motor to drive a flywheel and controlling the direction and speed of the motor in response to the movement of the structure.

25. (canceled)
